(19) United States
(12) Patent Application Publication
(10) Pub. No.: US 2026/0057430 A1
(43) Pub. Date: Feb. 26, 2026

(54) ITEM PRESENTATION TIMING CONSTRAINTS BASED ON CART ROUTE PREDICTION

(71) Applicant: Maplebear Inc., San Francisco, CA (US)

(72) Inventors: Amy Vaduthalakuzhy, San Francisco, CA (US); Dhruv Bhalla, Jersey City, NJ (US); Bryan Jacob Vanderhoof, Chicago, IL (US); Ikshu Bhalla, Burlingame, CA (US); Rui Feng, New York, NY (US); Robert Weathers Boyle, New York, NY (US); Dennis Deng, Gaithersburg, MD (US); Jiajie Tan, Milpitas, CA (US); Nicholas Sturm, Denver, CO (US); Audrey Quo Eing Chou, New York, NY (US)

(21) Appl. No.: 18/811,759

(22) Filed: Aug. 21, 2024

(51) Int. Cl. G06Q 30/0601; G06Q 30/02; G06Q 30/0201

(52) U.S. Cl. CPC G06Q 30/0631; G06Q 30/0201; G06Q 30/0281; G06Q 30/0633; G06Q 30/0639

(57) ABSTRACT

A smart cart presents candidate content objects to a user according to presentation constraints determined based on a predicted route of the smart cart. The smart cart obtains, from an item database, a plurality of candidate content objects to be presented to a user of a smart cart. The smart cart obtains a location of the smart cart in an environment. The smart cart applies a machine-learning route prediction model to the location of the smart cart to determine a future route of the smart cart. The smart cart determines, for each candidate content object, one or more presentation constraints based on the future route of the smart cart, wherein the presentation constraints constrain presentation of the candidate content object to the user to maximize a likelihood of the user engaging with the content object. The smart cart presents, via an electronic display, one or more of the candidate content objects according to the presentation constraints.

### BACKGROUND

Smart carts are currently being developed, which are implemented with technology to aid users during a store visit. However, there remains a need for improvements to the user interface provided by such smart carts. For example, in some instances, recommendations may be redundant and irrelevant if the item recommended has already been obtained by the user. In other instances, recommendations may be untimely, presenting items located in a previously traversed region of the store, or an out-of-the-way region of the store. Such relevancy and presentation timing challenges create technological problems in the implementation of smart carts.

### SUMMARY

A smart cart implemented a route prediction algorithm to determine presentation constraints in the presentation of content via the user interface. The cart applies a route prediction model to the tracked location of the smart cart (and, optionally, the obtained item(s), the candidate content object(s), and/or other contextual data) to determine a route for the remaining in-store trip. Based on the determined route, the cart determines presentation constraints for each candidate content object, e.g., including a time window to present the candidate content objector a portion of the route to present the candidate content object. The cart then presents the candidate content object(s) based on the presentation constraints. The route-informed presentation constraints tackle the technological problems and challenges in the smart cart user interface. For instance, content highlighting items to obtain are presented before the user arrives at the location of the item rather than after having passed the location.

In one or more embodiments, a smart cart implements one or more sensors to identify items in the cart. The smart cart may include one or more cameras, one or more load sensors, one or more item scanners, or some combination thereof. The sensor devices are positioned to capture information of items placed in the smart cart. The cameras can capture image data of the items in the cart. The load sensors can measure load data indicating a total load of items in the cart. The item scanners can capture unique item signatures to differentiate between items. Based on the sensor data, the cart can detect the items that were obtained. The cart may apply a recommendation model to the obtained item(s) to determine candidate content objects to present to the user. The smart cart may include one or more location sensors for tracking a location of the cart within an environment.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates a smart cart, in accordance with one or more embodiments.

FIG. 4 is an illustrative flowchart describing item presentation with timing constraints based on a route of the smart cart, in accordance with one or more embodiments.

FIG. 5 is a method flowchart describing the process of item presentation with timing constraints based on a route of the smart cart, in accordance with one or more embodiments.

FIG. 6 is a first example cart interface presenting recommended items, in accordance with one or more embodiments.

FIG. 7 is a second example cart interface presenting recommended items, in accordance with one or more embodiments.

### DETAILED DESCRIPTION

### Online System Environment

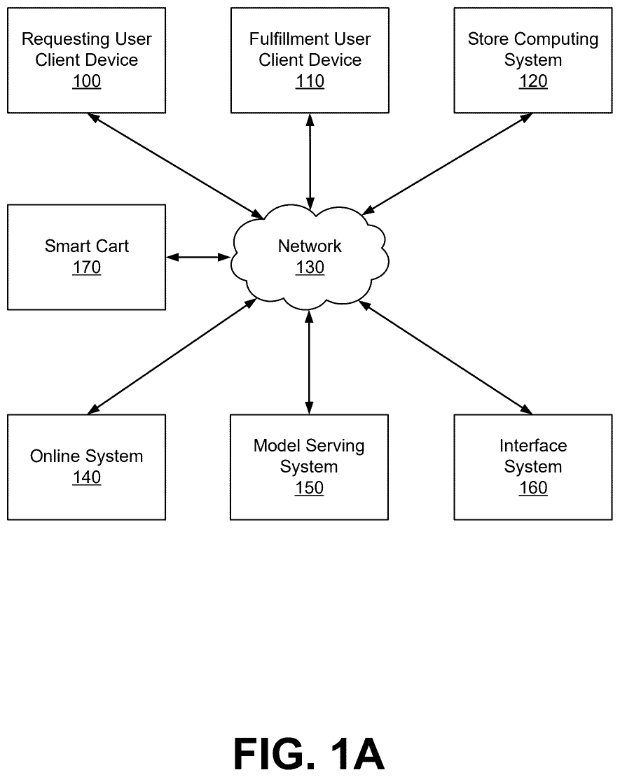

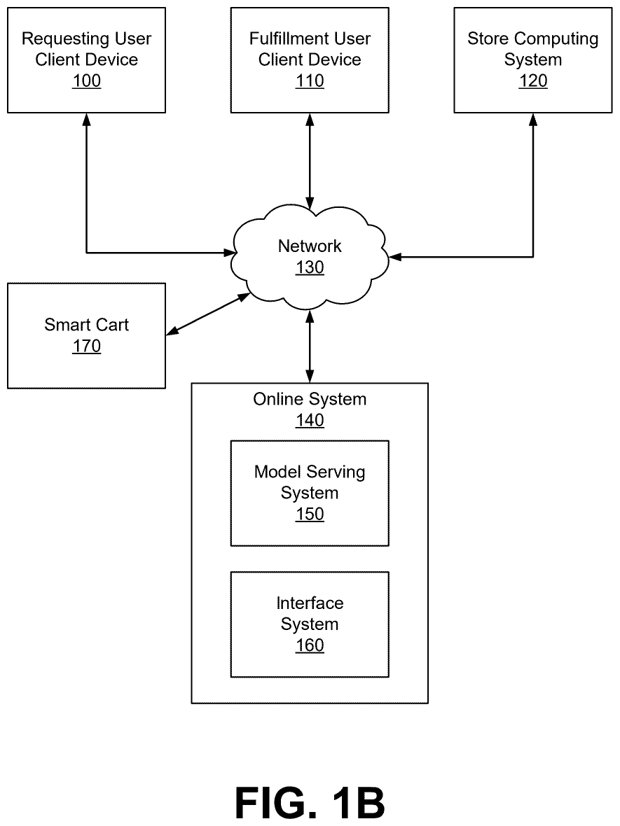

FIG. 1A illustrates an example system environment for an online system 140, in accordance with one or more embodiments. The system environment illustrated in FIG. 1A includes a requesting user client device 100, a fulfillment user client device 110, a store computing system 120, a network 130, an online system 140, a model serving system 150, an interface system 160, and a smart cart 170. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, requesting users, fulfillment users, and stores may be generically referred to as “users” of the online system 140. Additionally, while one requesting user client device 100, one fulfillment user client device 110, one store computing system 120, one smart cart 170 are illustrated in FIG. 1, any number of client devices, stores, or smart carts may interact with the online system 140. As such, there may be more than one requesting user client device 100, more than one fulfillment user client device 110, more than one store computing system 120, or more than one smart cart 170.

The requesting user client device 100 is a client device through which a requesting user may interact with the fulfillment user client device 110, the store computing system 120, or the online system 140. The requesting user client device 100 can be a personal or mobile computing device, such as a smartphone, a tablet, a laptop computer, or desktop computer. In some embodiments, the requesting user client device 100 executes a client application that uses an application programming interface (API) to communicate with the online system 140.

A requesting user uses the requesting user client device 100 to place an order with the online system 140. A requesting user may also be referred to as a requesting user that provides orders to the online system 140 for fulfillment. An order specifies a set of items to be delivered to the requesting user. An “item”, as used herein, means a good, a product, or a service that can be provided to the requesting user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more stores from which the ordered items should be collected.

The requesting user client device 100 presents an ordering interface to the requesting user. The ordering interface is a user interface that the requesting user can use to place an order with the online system 140. The ordering interface may be part of a client application operating on the requesting user client device 100. The ordering interface allows the requesting user to search for items that are available through the online system 140. To perform a search, the requesting user provides a query (e.g., a text query, an audio query, or a visual query) to the online system 140. The online system 140 processes the query to return query results to the requesting user. Based on the displayed results, the requesting user can select which items to add to a “shopping list.” A “shopping list,” as used herein, is a tentative set of items that the user has selected for an order but that has not yet been finalized for an order. The ordering interface allows a requesting user to update the shopping list, e.g., by changing the quantity of items, adding or removing items, or adding instructions for items that specify how the item should be collected. The user interface may also include options to provide input for user preferences. For example, the requesting user may, via the user interface, provide input tagging one or more items as favorite items. In another example, the requesting user may, via the user interface, provide input (e.g., in the form of user feedback or user messages) to past orders.

The requesting user client device 100 may receive additional content from the online system 140 to present to a requesting user. For example, the requesting user client device 100 may receive coupons, recipes, or item suggestions. The requesting user client device 100 may present the received additional content to the requesting user as the requesting user uses the requesting user client device 100 to place an order (e.g., as part of the ordering interface).

Additionally, the requesting user client device 100 includes a communication interface that allows the requesting user to communicate with a fulfillment user that is servicing the requesting user's order. This communication interface allows the user to input a text-based message to transmit to the fulfillment user client device 110 via the network 130. The fulfillment user client device 110 receives the message from the requesting user client device 100 and presents the message to the fulfillment user. The fulfillment user client device 110 also includes a communication interface that allows the fulfillment user to communicate with the requesting user. The fulfillment user client device 110 transmits a message provided by the fulfillment user to the requesting user client device 100 via the network 130. In some embodiments, messages sent between the requesting user client device 100 and the fulfillment user client device 110 are transmitted through the online system 140. In addition to text messages, the communication interfaces of the requesting user client device 100 and the fulfillment user client device 110 may allow the requesting user and the fulfillment user to communicate through audio or video communications, such as a phone call, a voice-over-IP call, or a video call.

The fulfillment user client device 110 is a client device through which a fulfillment user may interact with the requesting user client device 100, the store computing system 120, or the online system 140. The fulfillment user client device 110 can be a personal or mobile computing device, such as a smartphone, a tablet, a laptop computer, or desktop computer. In some embodiments, the fulfillment user client device 110 executes a client application that uses an application programming interface (API) to communicate with the online system 140.

The fulfillment user client device 110 receives orders from the online system 140 for the fulfillment user to service. A fulfillment user may also be referred to as a fulfillment user that fulfills orders by the requesting user. Items in the order may be presented in a particular sequence (i.e., display order) to optimize efficiency of the fulfillment user. A fulfillment user services an order by collecting the items listed in the order from a store. The fulfillment user client device 110 presents the items that are included in the requesting user's order to the fulfillment user in a collection interface. The collection interface is a user interface that provides information to the fulfillment user on which items to collect for a requesting user's order and the quantities of the items. In some embodiments, the collection interface provides multiple orders from multiple requesting users for the fulfillment user to service at the same time from the same store location. The collection interface further presents instructions that the requesting user may have included related to the collection of items in the order. Additionally, the collection interface may present a location of each item at the store, and may even specify a sequence in which the fulfillment user should collect the items for improved efficiency in collecting items. In some embodiments, the fulfillment user client device 110 transmits to the online system 140 or the requesting user client device 100 which items the fulfillment user has collected in real time as the fulfillment user collects the items.

The fulfillment user can use the fulfillment user client device 110 to keep track of the items that the fulfillment user has collected to ensure that the fulfillment user collects all of the items for an order. The fulfillment user client device 110 may include a barcode scanner that can determine an item identifier encoded in a barcode coupled to an item. The fulfillment user client device 110 compares this item identifier to items in the order that the fulfillment user is servicing, and if the item identifier corresponds to an item in the order, the fulfillment user client device 110 identifies the item as collected. In some embodiments, rather than or in addition to using a barcode scanner, the fulfillment user client device 110 captures one or more images of the item and determines the item identifier for the item based on the images. The fulfillment user client device 110 may determine the item identifier directly or by transmitting the images to the online system 140. Furthermore, the fulfillment user client device 110 determines a weight for items that are priced by weight. The fulfillment user client device 110 may prompt the fulfillment user to manually input the weight of an item or may communicate with a weighing system in the store location to receive the weight of an item.

When the fulfillment user has collected all of the items for an order, the fulfillment user client device 110 instructs a fulfillment user on where to deliver the items for a requesting user's order. For example, the fulfillment user client device 110 displays a delivery location from the order to the fulfillment user. The fulfillment user client device 110 also provides navigation instructions for the fulfillment user to travel from the store location to the delivery location. When a fulfillment user is servicing more than one order, the fulfillment user client device 110 identifies which items should be delivered to which delivery location. The fulfillment user client device 110 may provide navigation instructions from the store location to each of the delivery locations. The fulfillment user client device 110 may receive one or more delivery locations from the online system 140 and may provide the delivery locations to the fulfillment user so that the fulfillment user can deliver the corresponding one or more orders to those locations. The fulfillment user client device 110 may also provide navigation instructions for the fulfillment user from the store location from which the fulfillment user collected the items to the one or more delivery locations.

In some embodiments, the fulfillment user client device 110 tracks the location of the fulfillment user as the fulfillment user delivers orders to delivery locations. The fulfillment user client device 110 collects location data and transmits the location data to the online system 140. The online system 140 may transmit the location data to the requesting user client device 100 for display to the requesting user, so that the requesting user can keep track of when their order will be delivered. Additionally, the online system 140 may generate updated navigation instructions for the fulfillment user based on the fulfillment user's location. For example, if the fulfillment user takes a wrong turn while traveling to a delivery location, the online system 140 determines the fulfillment user's updated location based on location data from the fulfillment user client device 110 and generates updated navigation instructions for the fulfillment user based on the updated location.

The fulfillment user client device 110 may also provide a communication interface to the fulfillment user, e.g., to communicate with another user of the online system 140. For example, the communication interface of the fulfillment user client device 110 may present messages from a requesting user client device 100 to the fulfillment user client device 110. Such communication may be utilized when items in an order are unavailable at the store location. In such scenarios, the fulfillment user may query the requesting user for suitable substitution items to be obtained for the unavailable item. The messages may be in the form of text, audio, pictures, other digital manners of communicating information, etc.

In one or more embodiments, the fulfillment user is a single person who collects items for an order from a store location and delivers the order to the delivery location for the order. Alternatively, more than one person may serve the role as a fulfillment user for an order. For example, multiple people may collect the items at the store location for a single order. Similarly, the person who delivers an order to its delivery location may be different from the person or people who collected the items from the store location. In these embodiments, each person may have a fulfillment user client device 110 that they can use to interact with the online system 140.

Additionally, while the description herein may primarily refer to fulfillment users as humans, in some embodiments, some or all of the steps taken by the fulfillment user may be automated. For example, a semi- or fully-autonomous robot may collect items in a store location for an order and an autonomous vehicle may deliver an order to a requesting user from a store location.

The store computing system 120 is a computing system operated by a store that interacts with the online system 140. As used herein, a “store” is an entity that operates a “store location,” which is a store, warehouse, or other building from which a fulfillment user can collect items. The store computing system 120 stores and provides item data to the online system 140 and may regularly update the online system 140 with updated item data. For example, the store computing system 120 provides item data indicating which items are available at a particular store location and the quantities of those items. Additionally, the store computing system 120 may transmit updated item data to the online system 140 when an item is no longer available at the store location. Additionally, the store computing system 120 may provide the online system 140 with updated item prices, sales, or availabilities. Additionally, the store computing system 120 may receive payment information from the online system 140 for orders serviced by the online system 140. Alternatively, the store computing system 120 may provide payment to the online system 140 for some portion of the overall cost of a user's order (e.g., as a commission).

The store computing system 120 may provide the online system 140 with store data describing the store associated with the store computing system 120. The store data may include store name, store address, store website, store phone number, other identifying information, a type of store, an expense class of the store (e.g., $, $$, or $$$), opening hours, general dependability of items, diversity of items, types of items carried, or information describing the store, or some combination thereof. The online system 140 may further infer additional store data based on interactions between requesting users or fulfillment users and the store. For example, such store data based on the interactions may include requesting user reviews, fulfillment user reviews, popular items ordered, dependability of items, etc.

In one or more embodiments, the store computing system 120 may include a cart tracking system for tracking locations of smart carts throughout the in-store environment. In one or more embodiments, the cart tracking system may implement sensors positioned around the in-store environment and/or sensors coupled to the smart carts. In embodiments with sensors positioned around the in-store environment, the sensors may wirelessly communicate with counterpart device(s) on the smart carts to determine a location of each smart cart. In embodiments with sensors coupled to the smart carts, the sensors may wirelessly communicate with counterpart device(s) positioned around the in-store environment to determine a location of each smart cart. For example, the sensors may communicate with radiofrequency identifier (RFID) tags to triangulate a position of the sensors and/or the RFID tags. In one example, each smart cart includes a RFID reader as the sensor which receives signals from RFID tags positioned around the in-store environment. Based on the received signals, the tracking system can triangulate a position of the smart cart. In another example, each smart cart includes an RFID tag and RFID readers positioned around the in-store environment can read the signal from the cart's RFID tag to triangulate a position of the smart cart. In other embodiments, each smart cart may include additional components to aid in locating the smart cart in the in-store environment, including: wheel sensor(s), accelerometer(s), inertial measurement unit(s), magnetometer(s), imaging device(s), inclinometer(s), etc. Additional description relating to cart tracking is described in U.S. application Ser. No. 17/873,526 filed on Jul. 26, 2022, which is incorporated by reference in its entirety.

The requesting user client device 100, the fulfillment user client device 110, the store computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which requesting users can order items to be provided to them by a fulfillment user from a store. The online system 140 receives orders from a requesting user client device 100 through the network 130. The online system 140 selects a fulfillment user to service the requesting user's order and transmits the order to a fulfillment user client device 110 associated with the fulfillment user. The fulfillment user collects the ordered items from a store location and delivers the ordered items to the requesting user. The online system 140 may charge a requesting user for the order and provide portions of the payment from the requesting user to the fulfillment user and the store.

As an example, the online system 140 may allow a requesting user to order groceries from a grocery store. The requesting user's order may specify which groceries they want delivered from the grocery store and the quantities of each of the groceries. The requesting user's client device 100 transmits the requesting user's order to the online system 140 and the online system 140 selects a fulfillment user to travel to the grocery store location to collect the groceries ordered by the requesting user. Once the fulfillment user has collected the groceries ordered by the requesting user, the fulfillment user delivers the groceries to a location transmitted to the fulfillment user client device 110 by the online system 140.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are language models configured to perform one or more NLP tasks. The NLP tasks include, but are not limited to, text generation, query processing, machine translation, chatbots, and the like. In one or more embodiments, a language model of the model serving system 150 is configured as a transformer neural network architecture (i.e., a transformer model). Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. The language model can be configured as any other appropriate architecture including, but not limited to, transformer-based networks, long short-term memory (LSTM) networks, Markov networks, BART, generative-adversarial networks (GAN), diffusion models (e.g., Diffusion-LM), and the like.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 150 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

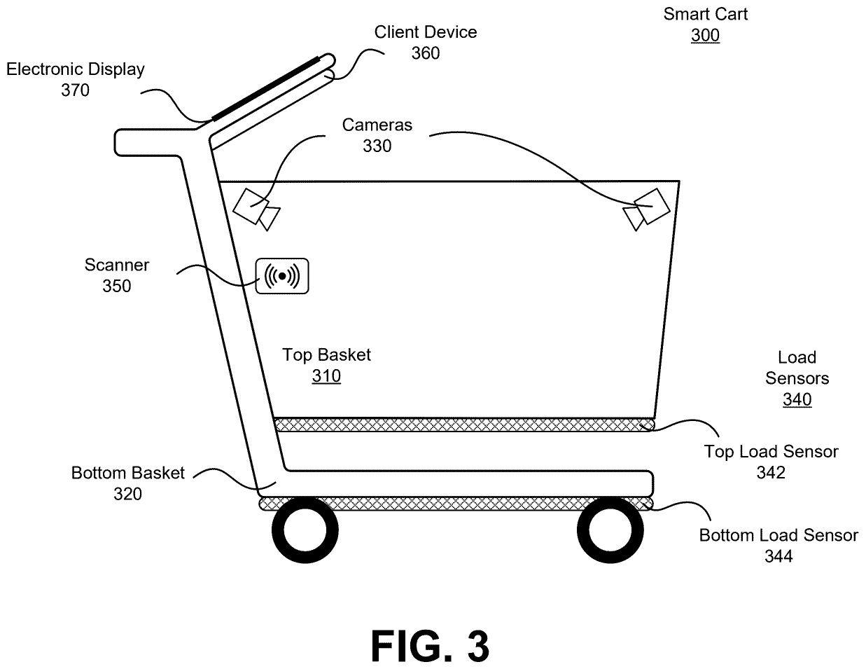

The smart cart 170 is a cart (e.g., a shopping cart) with one or more sensors and a computing device. The one or more sensors may detect various information relating to the smart cart 170. The sensors may include cameras and/or load sensors coupled to the baskets of the smart cart 170. The cameras can capture image data of items obtained. The load sensors can capture load data indicating a load on each basket. Further example sensors include a scanner for scanning items that are placed into the smart cart 170, a location sensor for tracking a position of the smart cart 170 in the in-store environment, etc. The computing device of the smart cart 170 processes the data captured by the sensors and, optionally, other data provided from other components of the system environment, e.g., the requesting user client device 100, the fulfillment user client device 110, the store computing system 120, the online system 140, etc. The computing device can provide content to the user of the smart cart 170 during their store visit. The content may be generated by the smart cart 170 and/or other components of the system environment. The functionality of the smart cart 170 is further described in FIGS. 3-7.

In some examples, a requesting user can use the smart cart 170. In such examples, the smart cart 170 may access a profile on the requesting user, e.g., to retrieve relevant user preference data. The requesting user could also provide a shopping list, such that the smart cart 170 can assist the requesting user in filling the shopping list, e.g., like an order.

In other examples, a fulfillment user can user the smart cart 170 to fulfill orders by requesting users of the online system 140. In such examples, the smart cart 170 can perform functionality of the fulfillment user client device 110. The smart cart 170 may also generate and provide fulfillment instructions to assist the fulfillment user in fulfilling the batch of orders.

FIG. 1B illustrates an example system environment for an online system 140, in accordance with one or more embodiments. The system environment illustrated in FIG. 1B includes a requesting user client device 100, a fulfillment user client device 110, a store computing system 120, a network 130, an online system 140, and a smart cart 170. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

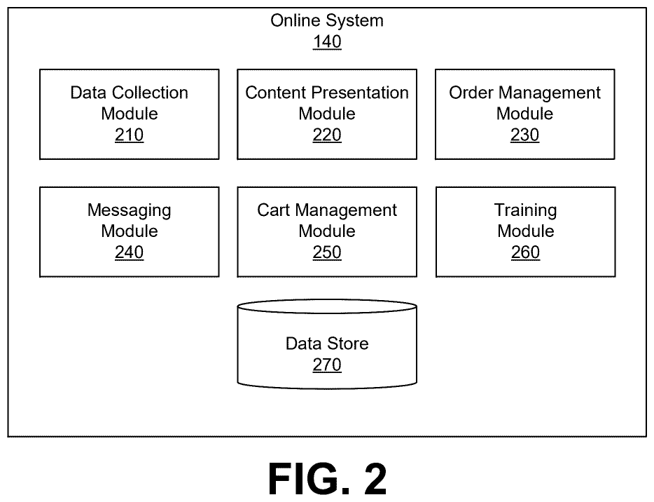

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140. The online system 140 is described in further detail below with regards to FIG. 2.

### Online System Architecture

FIG. 2 illustrates an example system architecture for an online system 140, in accordance with some embodiments. The system architecture illustrated in FIG. 2 includes a data collection module 210, a content presentation module 220, an order management module 230, a messaging module 240, a cart management module 250, a training module 260, and a data store 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 210 collects data used by the online system 140 and stores the data in the data store 270. The data collection module 210 may only collect data describing a user if the user has previously explicitly consented to the online system 140 collecting data describing the user. Additionally, the data collection module 210 may encrypt all data, including sensitive or personal data, describing users.

For example, the data collection module 210 collects requesting user data, which is information or data that describe characteristics of a requesting user. For example, the data collection module 210 may collect a requesting user's name, address, other demographic information (e.g., age range, family size, dietary restrictions or preferences, etc.), preferences (e.g., store visit frequency, order magnitude, etc.), previous orders, favorite items, favorite types of items, favorite stores, favorite fulfillment users, repeat fulfillment users, stored payment instruments, or some combination thereof. The requesting user data also may include default settings established by the requesting user, such as a default store/store location, payment instrument, delivery location, or delivery timeframe. The requesting user data may also include user preference data indicating one or more preferences, e.g., provided by the user and/or inferred by the online system 140. The data collection module 210 may collect the requesting user data from sensors on the requesting user client device 100 or based on the requesting user's interactions with the online system 140.

The data collection module 210 also collects item data, which is information or data that identifies and describes items that are available at a store location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the dependability of items in store locations, also referred to as “dependability.” For example, for each item-store combination (a particular item at a particular warehouse), the item data may include a time that the item was last found, a time that the item was last not found (a fulfillment user looked for the item but could not find it), the rate at which the item is found, or the popularity of the item. The data collection module 210 may collect item data from a store computing system 120, a fulfillment user client device 110, or the requesting user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 210 also collects fulfillment user data, which is information or data that describes characteristics of fulfillment users. For example, the data collection module 210 may collect the fulfillment user's name, the fulfillment user's location, how often the fulfillment user has serviced orders for the online system 140, a requesting user rating for the fulfillment user, a number of requesting users that have favorited the fulfillment user, which stores the fulfillment user has collected items at, or the fulfillment user's previous shopping history. Additionally, the fulfillment user data may include preferences expressed by the fulfillment user, such as their preferred stores to collect items at, how far they are willing to travel to deliver items to a requesting user, how many items they are willing to collect at a time, timeframes within which the fulfillment user is willing to service orders, payment information by which the fulfillment user is to be paid for servicing orders (e.g., a bank account), feedback from the fulfillment user in fulfilling requesting user orders, etc. The data collection module 210 collects fulfillment user data from sensors of the fulfillment user client device 110 or from the fulfillment user's interactions with the online system 140.

Additionally, the data collection module 210 collects order data, which is information or data that describes characteristics of an order. For example, order data may include item data for items that are included in the order, a delivery location for the order, a requesting user associated with the order, a store location from which the requesting user wants the ordered items collected, or a timeframe within which the requesting user wants the order delivered. Order data may further include information describing how the order was serviced, such as which fulfillment user serviced the order, when the order was delivered, or a rating that the requesting user gave the delivery of the order. In some embodiments, the order data includes user data for users associated with the order, such as requesting user data for a requesting user who placed the order or fulfillment user data for a fulfillment user who serviced the order.

The content presentation module 220 selects content for presentation to a user. For example, the content presentation module 220 selects which items to present to a requesting user while the requesting user is placing an order and/or using a smart cart during an in-store visit.

In embodiments with the requesting user placing an order, the content presentation module 220 generates and transmits an ordering interface for the requesting user to order items. The content presentation module 220 populates the ordering interface with items that the requesting user may select for adding to their order. In some embodiments, the content presentation module 220 presents a catalog of all items that are available to the requesting user, which the requesting user can browse to select items to order. The content presentation module 220 also may identify items that the requesting user is most likely to order and present those items to the requesting user. For example, the content presentation module 220 may score items and rank the items based on their scores. The content presentation module 220 displays the items with scores that exceed some threshold (e.g., the top n items or the p percentile of items).

In embodiments with the requesting user using a smart cart during an in-store visit, the content presentation module 220 may generate and transmit a cart interface for presentation on the smart cart 170. In other embodiments, the smart cart 170 may generate the cart interface. The cart interface may provide details about the user and/or the in-store visit, a list of one or more items in the smart cart, one or more item recommendations, or some combination thereof. The content presentation module 220 may implement a recommendation model for determining one or more item recommendations for presentation in the cart interface. The content presentation module 220 may train the recommendation model as a machine-learning model, and, optionally, as a multimodal model. In one or more embodiments, the recommendation model may input a list of items in a smart cart 170, a location of the smart cart 170 in the in-store environment, items in the item database, other contextual data, or some combination thereof.

The content presentation module 220 may use a scoring function to score items for presentation to a requesting user. The scoring function may score items for a requesting user based on item data for the items and requesting user data for the requesting user. The scoring function may determine a ranking score based on ranking parameter values for each item and a weight vector. In some embodiments, an item selection model trained as a machine-learning model may determine a likelihood that the requesting user will order the item. In some embodiments, the item selection model uses item embeddings describing items and requesting user embeddings describing requesting users to score items. These item embeddings and requesting user embeddings may be generated by separate machine-learning models and may be stored in the data store 270.

The order management module 230 manages orders by requesting users. The order management module 230 receives orders from a requesting user client device 100 and assigns the orders to fulfillment users for service based on fulfillment user data. For example, the order management module 230 assigns an order to a fulfillment user based on the fulfillment user's location and the location of the store from which the ordered items are to be collected. The order management module 230 may also assign an order to a fulfillment user based on how many items are in the order, a vehicle operated by the fulfillment user, the delivery location, the fulfillment user's preferences on how far to travel to deliver an order, the fulfillment user's ratings by requesting users, or how often a fulfillment user agrees to service an order.

In some embodiments, the order management module 230 determines when to assign an order to a fulfillment user based on a delivery timeframe requested by the requesting user with the order. The order management module 230 computes an estimated amount of time that it would take for a fulfillment user to collect the items for an order and deliver the ordered items to the delivery location for the order. The order management module 230 assigns the order to a fulfillment user at a time such that, if the fulfillment user immediately services the order, the fulfillment user is likely to deliver the order at a time within the requested timeframe. Thus, when the order management module 230 receives an order, the order management module 230 may delay in assigning the order to a fulfillment user if the requested timeframe is far enough in the future (i.e., the fulfillment user may be assigned at a later time and is still predicted to meet the requested timeframe).

When the order management module 230 assigns an order to a fulfillment user, the order management module 230 transmits the order to the fulfillment user client device 110 associated with the fulfillment user, e.g., with the content presentation module 220. The order management module 230 may also transmit navigation instructions from the fulfillment user's current location to the store location associated with the order. If the order includes items to collect from multiple store locations, the order management module 230 identifies the store locations to the fulfillment user and may also specify a sequence in which the fulfillment user should visit the store locations.

The order management module 230 may track the location of the fulfillment user through the fulfillment user client device 110 to determine when the fulfillment user arrives at the store location. When the fulfillment user arrives at the store location, the order management module 230 transmits the order to the fulfillment user client device 110 for display to the fulfillment user. As the fulfillment user uses the fulfillment user client device 110 to collect items at the store location, the order management module 230 receives item identifiers for items that the fulfillment user has collected for the order. In some embodiments, the order management module 230 receives images of items from the fulfillment user client device 110 and applies computer-vision techniques to the images to identify the items depicted by the images. The order management module 230 may track the progress of the fulfillment user as the fulfillment user collects items for an order and may transmit progress updates to the requesting user client device 100 that describe which items have been collected for the requesting user's order.

The order management module 230 determines when the fulfillment user has collected all of the items for an order. For example, the order management module 230 may receive a message from the fulfillment user client device 110 indicating that all of the items for an order have been collected. Alternatively, the order management module 230 may receive item identifiers for items collected by the fulfillment user and determine when all of the items in an order have been collected. When the order management module 230 determines that the fulfillment user has completed an order, the order management module 230 transmits the delivery location for the order to the fulfillment user client device 110. The order management module 230 may also transmit navigation instructions to the fulfillment user client device 110 that specify how to travel from the store location to the delivery location, or to a subsequent store location for further item collection. The order management module 230 tracks the location of the fulfillment user as the fulfillment user travels to the delivery location for an order, and updates the requesting user with the location of the fulfillment user so that the requesting user can track the progress of the order. In some embodiments, the order management module 230 computes an estimated time of arrival of the fulfillment user at the delivery location and provides the estimated time of arrival to the requesting user.

The order management module 230 coordinates payment by the requesting user for the order. The order management module 230 uses payment information provided by the requesting user (e.g., a credit card number or a bank account) to receive payment for the order. In some embodiments, the order management module 230 stores the payment information for use in subsequent orders by the requesting user. The order management module 230 computes a total cost for the order and charges the requesting user that cost. The order management module 230 may provide a portion of the total cost to the fulfillment user for servicing the order, and another portion of the total cost to the store. The order management module 230 may further provide an option to the requesting user to provide a tip to the fulfillment user, e.g., for outstanding service.

The messaging module 240 facilitates communication between the requesting user client device 100 and the fulfillment user client device 110. As noted above, a requesting user may use a requesting user client device 100 to send a message to the fulfillment user client device 110. The messaging module 240 receives the message from the requesting user client device 100 and transmits the message to the fulfillment user client device 110 for presentation to the fulfillment user. The fulfillment user may use the fulfillment user client device 110 to send a message to the requesting user client device 100 in a similar manner. Communications between the requesting user and the fulfillment user may be provided to the content presentation module 220 in scoring items for a requesting user.

The cart management module 250 manages the smart carts in use at a store location. In some embodiments, management may include performing analyses of the data captured by the sensors of the smart cart and providing content to the user of the smart cart via an electronic display of the smart cart. In some embodiments, the cart management module 250 may collect data from the smart carts, e.g., to train models implemented with the data. In such embodiments, the online system 140 may train the models, e.g., via the training module 260, and provide the trained models to the smart carts. In other embodiments, the models are stored at the online system 140. The smart cart 170 provides inputs to the models, and the online system 140 can return outputs by the models. The cart management module 250 may also provide any other data to the smart carts, e.g., information on users, user preference data, historical orders by users, information on items at the store locations, traffic flow of a store location, orders to be fulfilled, etc.

In one or more embodiments, the cart management module 250 tracks locations of the smart carts 170 in an in-store environment. In one or more embodiments, the cart management module 250 may work in conjunction with a cart tracking system, e.g., implemented by the store. The cart tracking system may provide a location of each smart cart 170 in the in-store environment to the cart management module 250. The cart management module 250 may map out the smart carts in the in-store environment, optionally logging information and other data relating to in-store visits. In other embodiments, the cart management module 250 may receive a location of each cart as self-tracked by the cart, e.g., with a location sensor.

The training module 260 trains machine-learning models used by the online system 140. For example, the training module 260 may train the item selection model, the dependability model, the query processing models, the models associated with the smart cart (described below in FIGS. 3-5), or any of the machine-learned models deployed by the model serving system 150. The online system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The training module 260 generates the set of parameters (e.g., the particular values of the parameters) for a machine-learning model by “training” the machine-learning model. Once trained, the machine-learning model uses the set of parameters to transform inputs into outputs.

The training module 260 trains a machine-learning model based on a set of training examples. Each training example includes input data to which the machine-learning model is applied to generate an output. For example, each training example may include requesting user data, fulfillment user data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The training module 260 may apply an iterative process to train a machine-learning model whereby the training module 260 updates parameter values of the machine-learning model based on each of the set of training examples. The training examples may be processed together, individually, or in batches. To train a machine-learning model based on a training example, the training module 260 applies the machine-learning model to the input data in the training example to generate an output based on a current set of parameter values. The training module 260 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross-entropy loss function. The training module 260 updates the set of parameters for the machine-learning model based on the score generated by the loss function. For example, the training module 260 may apply gradient descent to update the set of parameters.

The data store 270 stores data used by the online system 140. For example, the data store 270 stores requesting user data, store data, item data, order data, and fulfillment user data for use by the online system 140. The data store 270 also stores trained machine-learning models trained by the training module 260. For example, the data store 270 may store the set of parameters for a trained machine-learning model on one or more non-transitory, computer-readable media. The data store 270 uses computer-readable media to store data, and may use databases to organize the stored data.

With respect to the machine-learned models hosted by the model serving system 150, the machine-learned models may already be trained by a separate entity from the entity responsible for the online system 140. In one or more other embodiments, when the model serving system 150 is included in the online system 140, the training module 260 may further train parameters of the machine-learned model based on data specific to the online system 140 stored in the data store 270. As an example, the training module 260 may obtain a pre-trained transformer language model and further fine-tune the parameters of the transformer model using training data stored in the data store 270. The training module 260 may provide the model to the model serving system 150 for deployment.

### Smart Cart

FIG. 3 illustrates a smart cart 300, in accordance with some embodiments. The smart cart 300 is an embodiment of the smart cart 170. The smart cart 300 may be operated by a user in a store location to obtain and purchase items listed for sale in the store location. In one or more embodiments, the smart cart 300 includes a top basket 310 and a bottom basket 320 atop a set of wheels. The smart cart 300 further comprises a plurality of cameras 330, load sensors 340, a scanner 350, a client device 360, and an electronic display 370. Alternative embodiments may include more, fewer, or different components from those illustrated in FIG. 3, and the functionality of each component may be divided between the components differently from the description below. For example, the smart cart 300 may further include other input and/or output devices, e.g., microphones or speakers. In other examples, the smart cart 300 may include a location sensor for tracking a location of the smart cart 300 within an in and around a store location. In yet other examples, the smart cart 300 may include different number of baskets, or each basket may be further subdivided into compartments, etc. Additionally, each component may perform their respective functionalities in response to a request from a human, or automatically without human intervention.

The baskets store items obtained by a user whilst traversing the store location and prior to checking out. As shown in FIG. 3, the baskets may include, e.g., a top basket 310 and a bottom basket 320. In other embodiments, there may be any other number of baskets. In additional embodiments, a basket may be subdivided into multiple compartments. In yet additional embodiments, the baskets may be disparately dimensioned, e.g., one basket may be shallow and positioned near the handle, whereas another basket may be deep and cylindrical for storing long skinny items.

The cameras 330 capture image data of an interior of the baskets. In general, the cameras 330 capture image data to identify and detect items placed in the smart cart 300. The captured image data may include photos or video. In the embodiment shown in FIG. 3, the cameras 330 are positioned internal facing for the top basket 310.

In other embodiments, each basket may include one or more of the cameras 330 positioned to identify and detect items placed in the respective baskets. In yet other embodiments, a subset of the baskets may include one or more cameras, whereas other baskets do not have dedicated cameras. In still other embodiments, cameras may be positioned to be in view of one or more baskets, i.e., having a field of view that encompasses the one or more baskets.

The load sensors 340 measure a weight of items placed in the baskets. Each load sensor generates load data indicating a measure of weight or mass of items placed in each respective basket over time. For example, the load data may be zeroed when the basket is emptied, and, when a user places a first item into the basket, the load sensor may record the change in load atop the load the sensor as the load data. The load data may be time series data of the total load, or change in load. In other embodiments, the load data may indicate a load per item placed into the smart cart 300 recorded at a particular timestamp during the in-store visit.

In one or more embodiments, each basket may be coupled to a load sensor. In other embodiments, a subset of baskets may be outfitted with load sensors, whereas others do not have dedicated load sensors. As shown in FIG. 3, there is a top load sensor 315 for the top basket 310 and a bottom load sensor 325 for the bottom basket 320. In some embodiments, a load sensor may include one or more load sensing devices, e.g., for sensing the loads on different portions of a basket.

In some embodiments, the smart cart 300 includes the scanner 350. In such embodiments, the scanner 350 may scan uniquely tagged items. The scanner 350 may record the entering of the uniquely tagged items as scan data. The scanner 350 scans a signature of each item placed in the smart cart 300. The signature is a unique identifier for each item, e.g., a barcode, a RFID signature, QR code, etc. The range of the scanner 350 may toggled to only detect items placed into the smart cart 300, while not registering nearby external items as entering the cart.

In one or more embodiments, the scanner 350 is a radio-frequency identification (RFID) scanner. Accordingly, items available at the store location are tagged with RFID chips. The RFID chips may use active emission and/or passive emission. To be an active emitter, the RFID chip includes a power source (e.g., a battery) that enables the RFID chip to emit a distinct radio-frequency signature. To be a passive emitter, the RFID chip does not have its own power source. Rather, the RFID chip receives power from the RFID scanner's electromagnetic waves, thereby inducing a current in the RFID chip's antenna.

In other embodiments, the scanner 350 may be a barcode scanner. In such embodiments, each item may be tagged with a barcode. The store system may log a database of items with corresponding barcodes, such that the scanner 350 may capture light reflected off the barcode to determine the unique barcode signature of the item. In one or more related embodiments, the scanner 350 may be a quick-response (QR) code scanner. Similar to the barcode scanner, each item is tagged with a QR code that is unique to the item. The scanner 350 captures an image of the QR code and compares the detected QR code to a database of QR codes associated with items to identify an item that has entered the smart cart 300.

In some embodiments, the smart cart 300 may include a location sensor for tracking of a position of the smart cart in the store location. For example, the location sensor may be BlueTooth enabled, RFID enabled, GPS enabled, etc. The location sensor may also include an accelerometer, an inertial measurement unit, a magnetometer, wheel sensors, etc. The location sensor can leverage such devices to determine the cart's position, velocity, acceleration, etc. Other technologies for tracking may also be implemented. For example, the store location may be outfitted with a camera system to capture images of the smart carts as they traverse around the in-store environment.

The client device 360 is a computing device that analyzes the data captured by the smart cart 300. The client device 360 may perform functionality of the requesting user client device 100 and the fulfillment user client device 110. In the context of a requesting user utilizing the smart cart 300, the client device 360 may present content that would be presented to the requesting user client device 100, e.g., content recommending various items. In the context of a fulfillment user utilizing the smart cart, the client device 360 may present content that would be presented to the fulfillment user client device 110, e.g., an order assigned to the fulfillment user and comprising a list of items and their positions in the store location. Accordingly, the client device 360 may be communicatively connected to an online system (e.g., the online system 140, via the network 130).

In general, the client device 360 analyzes the data captured by the smart cart 300 to determine content for the user of the smart cart 300. For example, the client device 360 may, based on sensor data, detect items obtained by the user and currently in the smart cart 300 (also referred to as “obtained items,” or “items in cart”). The client device 360 may also track or receive a location of the smart cart 300 in the in-store environment. The client device 360 may also apply a recommendation model to the sensor data and/or the location of the smart cart 300 to determine one or more items to recommend to the user during the in-store visit (also referred to as “recommended items,” or “item recommendations”). In some embodiments, the recommendation model further considers item information (e.g., stored by the online system 140) or other contextual data relating to the in-store visit (e.g., user data, in-store visit data, etc.). In some embodiments, the recommendation model may be locally stored on the client device 360. In other embodiments, the recommendation model is stored on an online system (e.g., the online system 140). In such embodiments, the client device 360 provides data to the online system which applies the recommendation model to return the recommended items. The client device 360 may further provide navigation instructions to obtaining the recommended items, which may be based on the cart's location and each recommended item's location.

The electronic display 370 provides an interface for a user of the smart cart 300. The electronic display 370 may be configured to provide content to a user and may also be configured to receive user input. The electronic display 370 may include other input and/or output devices, e.g., a microphone and/or a speaker. The electronic display 370 may be a component of the client device 360.

### Item Presentation With Timing Constraints Based on Cart Route

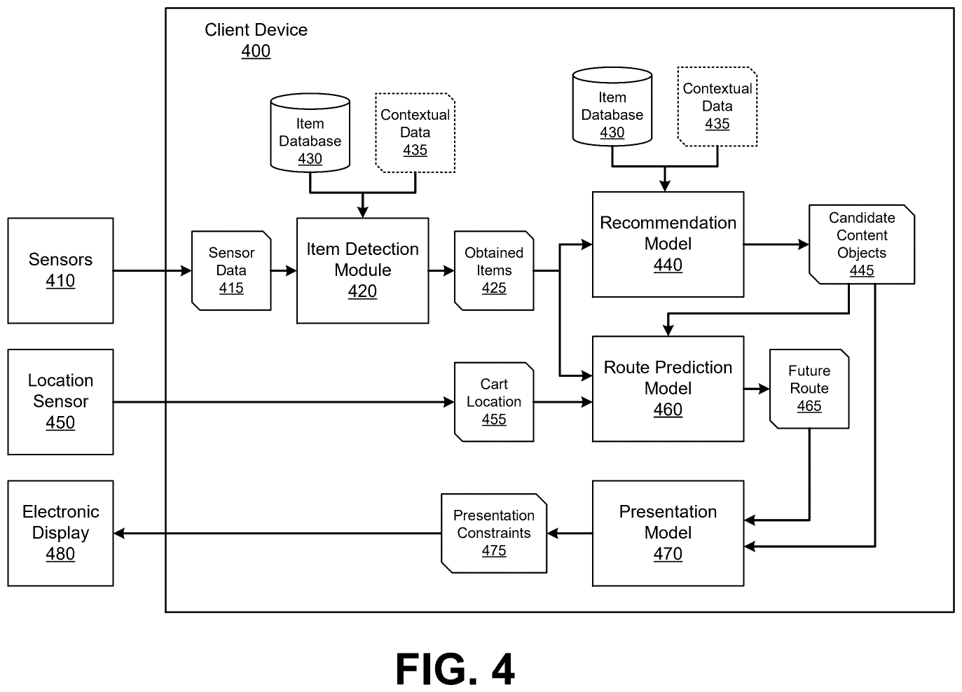

FIG. 4 is an illustrative flowchart describing item presentation with timing constraints based on the smart cart's route, in accordance with one or more embodiments. The description of FIG. 4 focuses on the interplay between sensors 410 of a smart cart (e.g., the smart cart 300) and a client device 400 of the smart cart (e.g., the client device 360 of the smart cart 300). In other embodiments, some or all of the functionality of the client device 400 described in FIG. 4 can be performed by the online system 140 (e.g., the cart management module 250). Moreover, the principles described in FIG. 4 are applicable to any user, e.g., a requesting user or a fulfillment user.

The sensors 410 capture sensor data 415 that is provided to the client device 400. The sensors 410 may include cameras, load sensors, item scanners, or some combination thereof. The cameras may provide image data on items placed in the cart; the load sensors may provide load data on items placed in the cart, and the item scanner may provide item scan data. The client device 400 may also obtain or retrieve other relevant data, e.g., item data from an item database 430 and contextual data 435 around the trip. The contextual data and/or the item data may be stored locally or on an online system (e.g., the online system 140). The location sensor 450 (which may be one of the sensors 410) tracks a cart location 455. In one or more embodiments, an environment (e.g., in and/or around the store location) may be divided into traversable regions (e.g., aisles) and non-traversable regions (e.g., where fixtures are positioned, boundaries of the store location, etc.). The environment may also be subdivided, e.g., tiled into discrete coordinates.

The client device 400 may include an item detection module 420 that inputs the sensor data 415 to determine one or more obtained items 425. The one or more obtained items 425 refer to items that have been obtained by the user and placed in the smart cart 300. The item detection module 420 may further leverage item data from an item database 430, which stores information on items offered by the store location. The item database 430 may be a component of or part of the data store 270. The item detection module 420 may further input other contextual data 435. For example, the contextual data 435 may include one or more characteristics of the shopping trip, one or more characteristics of the user operating the smart cart, user preference data, tracking data of the smart cart, order information being fulfilled by the user (e.g., in instances where the user is a fulfillment user), or other data in the online system.

The item detection module 420 may identify the obtained items 425 through one or more approaches. In instances with the item scan data, the items detected in the item scan data would be the obtained items 425. In such instances, the image data and the load data may be used to verify the item scan data. In instances without the item scan data, the item detection module 420 may utilize an object recognition model that matches images pertaining to the item from the image data and/or a weight of the item from the load data to stored images and/or a stored weight of the item in the item database 430. For example, the item detection module 420 may leverage an image classifier to determine the item from the image data. In other embodiments, another type of classification model may be trained and implemented to input both the image data and the load data to classify which item was obtained. The contextual data 435 may also be used in the identification process. For example, if an item entering the smart cart is known to be shelved in a different aisle than the aisle where the smart cart currently is positioned in, then the item detection module 420 may annotate the discrepancy (e.g., as a confidence score) and/or invalidate the item detection.

The recommendation model 440 determines one or more candidate content objects 445 based on the obtained items 425, the cart location 455, item data, contextual data, or some combination thereof. Content objects are data objects including some content that can be presented to a user. In one or more embodiments, a content object relates to one or more items available at in-store locations. The recommendation model 440 may be a machine-learning model trained to predict a likelihood that an item is obtained by the user when recommended (also referred to as a “conversion likelihood”). The recommendation model 440 outputs the likelihood based on input data. For example, the recommendation model 440 may maintain a promoted list of items that may be recommended to users, e.g., identified in the item database 430. Such items may be highlighted in the content objects. In some example implementations, the promoted list may include all items offered by the store. The recommendation model 440 may remove items in the promoted list based on items already obtained by the user. For example, the promoted list of items may include a particular ice cream, but the user has already obtained that ice cream, so that item is withheld from recommendation. The recommendation model 440 determines a conversion likelihood for each item in the promoted list, and the recommendation model 440 determines the one or more candidate content objects based on the conversion likelihoods. For example, the recommendation model 440 may rank all items in the promoted list based on the conversion likelihoods to determine the candidate content objects from top-ranked items.

The recommendation model 440 may further determine the likelihood of interacting with each candidate content object based on the cart location 455 relative to an item location in the in-store environment. For example, items located further away from the smart cart are less likely to be obtained than items located in the vicinity of the smart cart. In some embodiments, the recommendation model 440 further determines the likelihood based on a route taken by the smart cart. For example, items located in traversed regions of the in-store environment may be less likely to be obtained than items located in a yet-to-be-traversed region of the in-store environment.

The recommendation model 440 may further input other contextual data 435 in determining the likelihood of an item to be obtained. For example, the recommendation model 440 may input user preference data, or past in-store visit data. This may result in determining higher conversion likelihoods for favorited items over non-favorited items. In another example, the recommendation model 440 may determine higher likelihoods for items ordered or purchased more frequently compared to infrequent items. In a further example, items obtained in the past at a frequency of once every two in-store visits can affect the likelihood scoring. With this example frequency, if the user in the previous in-store visit obtained the item, then the user is less likely to obtain the item in this current in-store visit.

In one or more embodiments, the recommendation model 440 may leverage a recipe recommendation algorithm to identify available recipes based on the obtained items 425. Recommended recipes may include additional items that can then be recommended to the user. For example, if the user obtains chicken thighs and carrots, the recipe recommendation algorithm may recommend a chicken noodle soup recipe that already includes chicken thighs and carrots. The interface may further provide user-selectable options for accepting a recipe recommendation. The recommendation model 440 may subsequently recommend not-yet-obtained items (also referred to as needed items) in the recipe, e.g., celery, onions, garlic, chicken stock, noodles, etc. The recipe recommendation algorithm may further evaluate whether needed items are located in traversed regions or yet-to-be-traversed regions, such that recipes with many needed items in previously traversed regions would be less likely to be recommended compared to recipes with few (if any) needed items in previously traversed regions.

In some embodiments, the recommendation model 440 may also output a promotion for an item presented in a content object. For example, the recommendation model 440 may determine an increase in conversion likelihood as an effect of providing the promotion for the recommended item. If there are a plurality of available promotions, the recommendation model 440 may select the promotion that maximizes the increase in conversion likelihood.

The recommendation model 440 may be trained on historical order data, e.g., by the training module 260. The training module 260 gathers the historical order data and one or more items recommended during the historical order. The training module 260 may also retrieve other sensor data or contextual data associated with the historical orders. The training module 260 may score the recommended items in the historical orders based on whether the user ended up obtaining the recommended item. For example, if the user obtained the item, then the training module 260 may score the recommended item with a score of 1, and, alternatively, a score of 0, if not obtained. The training module 260 may train the recommendation model 440 with the recommended items and corresponding score. The recommendation model 440 may output a binary label, e.g., recommend or not recommend, or may output a score indicating a likelihood that the item will be obtained, e.g., in the range of 0 to 1.

The route prediction model 460 determines a future route 465 of the cart based on the tracked cart location 455. As the cart traverses the environment, the location sensor 450 may periodically record and provide the cart location 455 to the client device 400. The cart may track the traveled route. The cart may apply the route prediction model 460 to the cart location 455 and/or the traveled route to determine a future route 465.

The route prediction model 460 may further input the obtained item(s) 425, the candidate content object(s) 445, user data, other contextual data 435, or some combination thereof, in determining the future route 465 of the cart. For example, if a user has a list of items to be obtained (e.g., provided to the client device 400 ahead of the in-store trip and stored as user data), and the client device 400 determines all the items on the list have been obtained, then the route prediction model 460 may predict that the future route 465 may be a direct path to a checkout. In another example, a particular user may travel a standard route in past trips. Accordingly, the route prediction model 460 may input the past trip data to determine the future route 465 would, with a high likelihood, adhere to the standard route of the user.

The route prediction model 460 may, in another example, iteratively refine the future route 465 prediction during the in-store trip. As a user accepts or rejects candidate content objects presented (i.e., recommended) to the user, the route prediction model 460 may update the route prediction. In other embodiments, as the user continues to traverse the in-store environment, the future route 465 can be iteratively refined with the real-time location tracking. A training module may further score the route prediction model 460 based on differences between the predicted route and the traversed route. In one or more embodiments, the route prediction model 460 may output a set of possible future routes with some likelihood of being taken. In one or more embodiments, the route prediction model 460 is a machine-learning model that is trained based on historical trips by users of the in-store environment. The route prediction model 460 may be trained by scoring route predictions against routes eventually taken by the cart. A training module may adjust parameters of the route prediction model 460 to optimize the scoring (e.g., to improve accuracy of route predictions).

The presentation model 470 determines presentation constraints 475 for the candidate content objects 445 based on the future route 465 and a position of each of the candidate content objects 445. For example, the presentation module 470 may determine presentation constraints 475 specific to each candidate content object. The presentation constraints 475 may include a time window eligible for presentation of the candidate content object and/or a portion of the future route 465 to present the candidate content object. For example, the time window may be in the next five to ten minutes. The presentation model 470 may determine the time window and/or the portion of the route further based on the cart location 455 relative to a position of the candidate content object. For example, if one or more items highlighted in the candidate content object are located in a previously traversed region, the presentation model 470 may determine that there is no eligible time window for presentation of the candidate content object. As another example, if one or more items highlighted in the candidate content object are located close to the checkout, the presentation model 470 may output the presentation constraint close to an end of the trip. The presentation model 470 may determine the presentation constraints 475 by subdividing the future route 465 or a predicted remainder of time for the trip to each of the candidate content objects 445. In some embodiments, the presentation model 470 may determine conditions precedent to presenting a candidate content object. For example, one condition precedent may depend on whether the smart cart traverses into a particular region, or if the smart cart traverses along one of many predicted possible future routes. Upon the condition precedent being satisfied (i.e., the smart cart determines that its location is in a particular region, or that the particular future route is being traveled), then the smart cart may present the candidate content object. In one or more embodiments, the presentation model 470 may be a machine-learning model. In such embodiments, the presentation model 470 may be trained according to whether the user obtained the candidate content object(s) 445.

In some embodiments, the presentation model 470 filters the candidate content objects based on the presentation constraints and selects content objects to present from the remaining set. If the presentation constraints are not met, the presentation model 470 filters out those content objects from presentation candidacy, yielding a remaining subset of candidate content objects. The presentation model 470 may score the remaining candidate content objects based the user data and item data associated with the one or more items related to the candidate content object. The presentation model 470 may select candidate content objects to present based on the scores.

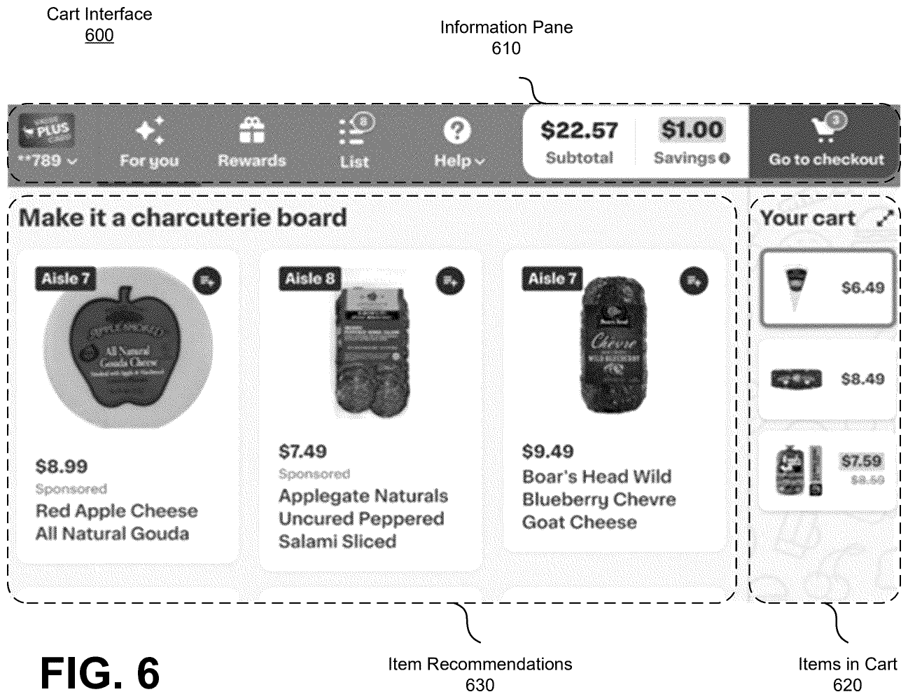

The electronic display 480 presents the candidate content objects 445 according to the presentation constraints 475 (e.g., on a cart interface, examples of which are shown in FIGS. 6 & 7). The presentation constraints 475 constrain presentation of the candidate content objects 445, e.g., to be presented only during an eligible time window and/or only during an eligible portion of the route. The electronic display 480 may receive input from the user in conjunction with the cart interface as user interaction with the presented content object 445.

In some embodiments, the client device 400 includes the electronic display 480 (and/or other output devices) that can present content including the candidate content objects 445. For example, an image of one candidate content object may pop up on the electronic display 480. In additional embodiments, the electronic display 480 may also display the accompanying promotion for the candidate content object, e.g., 10% off coupon. In yet other embodiments, the electronic display 480 may display instructions to locate the candidate content object. For example, the electronic display 480 may indicate that the candidate content object is further down the aisle, on the left, on the 2^{nd} shelf from the top.

The electronic display 480 may further display multiple candidate content objects, e.g., with text that a title that reads “Check-out these items! ” The recommendation model 440 may select a set of recommended items with some common theme, e.g., in a recipe, commonly paired together, etc. In other embodiments, the recommendation model 440 may select the set of recommended items to ensure some diversity, e.g., to avoid presenting multiple items of the same item type, but perhaps from different brands. In some embodiments, the user may swipe through the different recommended items, e.g., ordered based on the predicted conversion likelihoods. The interface may further include user-selectable options. For example, in response to a recommended recipe, the user may select between a first option to accept the recommendation or a second option to reject the recommendation. In another example with a recommended item, there can be one option to accept the recommendation and a second option to reject the recommendation. In response to selection of the acceptance option, the interface may provide navigation instructions.

In some embodiments, the client device 400 may further determine navigation instructions for candidate content objects 445. The client device 400 may determine the navigation instructions based on the cart location 455 and the location of the recommended item. The navigation instructions may also be based on the traffic flow. The resulting navigation instructions may include one or more steps to direct the fulfillment user to the next item, e.g., down the aisle, turn right, and turn right at the third aisle, item on the left halfway up the aisle.

In some embodiments, the user identifies an item (e.g., a candidate content object) as unavailable. The user may provide such message or indication through the client device 400 and/or the electronic display 480. In response, the recommendation model 440 may trigger a replacement workflow to identify a suitable substitution item in lieu of the unavailable item. The recommendation model 440 may score items in the item database 430 based on similarities between the unavailable item and the other items. Based on the scores, the recommendation model 440 may select one for display to the user, e.g., via the electronic display 480. The recommendation model 440 may further consider the other contextual data 435 in determining the substitution item. For example, the recommendation model 440 may weigh the current position of the cart and the positions of the other items in candidacy for substitution of the unavailable item, e.g., between two similarly scored items, the closer item may be recommended as a substitute. As another example, the recommendation model 440 may weigh user preference data in determining the score of the items in candidacy as a substitute to the unavailable item.

### Example Methods

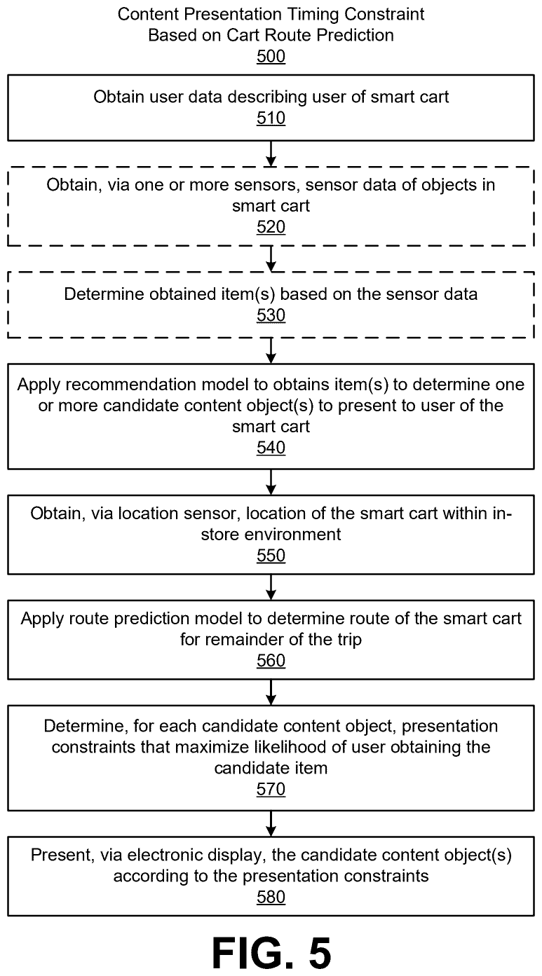

FIG. 5 is a method flowchart describing the process 500 of item presentation with timing constraints based on a route of the smart cart, in accordance with one or more embodiments. The description of FIG. 5 is in the perspective of the smart cart (e.g., the smart cart 170, the smart cart 300, etc.), but in other embodiments, any computing system or device may perform any, some, or all of the steps. For example, one or more of the steps may be performed by an online system (e.g., the online system 140).

The smart cart obtains 510 user data describing a user of the smart cart. The user data may include past in-store trips, order history, favorited items, etc. The past in-store trips may describe routes taken by the user, items obtained along the route, timing of the trip, etc. Order history may include items added to orders, e.g., including items obtained or added in response to presentation of content objects via the cart interface. The user data may further include a shopping list provided or inferred by the online system.

In some embodiments, the smart cart obtains 520, via one or more sensors, sensor data describing objects in the smart cart. These sensors may include cameras, load sensors, item scanners, etc. For example, one or more cameras capture image data of items in the basket. In another example, one or more load sensors can capture load data of the basket. In another example, a scanner implemented in the smart cart captures item scan data of items placed in the smart cart. The scanner may scan RFID signatures, item barcodes, etc.

In some embodiments, the smart cart determines 530 obtained item(s) based on the sensor data. For example, the smart cart may utilize an item detection model to classify images of an item to determine what item from the store was obtained. The item detection model may further (or alternatively) classify based on weight of the obtained item in the load data. The item detection model may further input other data, e.g., item scan data, contextual data, etc. The item detection model may include a mapping of item scan data to items in the in-store environment, e.g., each barcode is linked to one item.

The smart cart applies 540 a recommendation model to the obtained item(s) to determine one or more candidate content object(s) that may be presented to the user of the smart cart. The recommendation model may score the likelihood that the user would obtain the item based on the obtained item(s), the cart location, other contextual data, or some combination thereof. In one example, items similar to obtained items (e.g., in the same category) may be scored lower, to prevent redundant items (e.g., users would be less likely to obtain another cereal if their favorite cereal is already obtained and in the smart cart). The recommendation model may further leverage a recipe recommendation algorithm to determine whether one or more recipes may be recommended to the user based on the obtained items. Items in the recommended recipes may be recommended to the user as recommended items.

The smart cart obtains 550, via a location sensor, a location of the smart cart within the in-store environment. The location may be represented in spatial coordinates. The spatial coordinates may be discrete (e.g., tiled floor plan) or continuous. The smart cart may determine a route traveled by the smart cart during the in-store visit. For example, as the smart cart moves around the in-store environment, location data and associated timestamps may be logged. In one or more embodiments, the smart cart may obtain the location data through self-tracking with the location sensor. In such embodiments, the location sensor may include an accelerometer, an inertial measurement unit, a magnetometer, an emitter or receiver, wheel sensors, etc. In other embodiments, the smart cart may obtain the location data through a tracking system implemented in the in-store environment. The location sensor may frequently determine the location of the smart cart, such that the smart cart can track its traveled route during the trip.

The smart cart applies 560 a route prediction model to the location of the smart cart to determine a future route of the smart cart for a remainder of the trip. The route prediction model may present a set of possible future routes that may be taken by the smart cart. The route prediction model may further input the obtained item(s), the candidate content object(s), other contextual data, or some combination thereof, in determining the future route of the cart. The route prediction model may be a machine-learning model trained based on historical trips by users of the in-store environment. The route prediction model may be trained by scoring route predictions against routes eventually taken by the cart. Parameters of the model may be adjusted to optimize the scoring (e.g., to improve accuracy of route predictions).

The smart cart determines 570, for each candidate content object, one or more presentation constraints that maximize a likelihood that the user obtains the candidate content object. The smart cart may determine presentation constraints that include a time window eligible for presentation of the candidate content object and/or a portion of the future route to present the candidate content object. For example, the time window may be in the next five to ten minutes. The smart cart may determine the time window and/or the portion of the route further based on the cart location relative to a position of the candidate content object. The smart cart may determine the presentation constraints by subdividing the future route or a predicted remainder of time for the trip to each of the candidate content objects. In some embodiments, the presentation model may determine conditions precedent to presenting a candidate content object. For example, one condition precedent may depend on whether the smart cart traverses into a particular region, or if the smart cart traverses along one of many predicted possible future routes. Upon the condition precedent being satisfied (e.g., the smart cart determines that its location is in a particular region, or that the particular future route is being traveled), then the smart cart may present the candidate content object.

The smart cart presents 580, via an electronic display, the candidate content objects according to the presentation constraints. The presentation constraints constrain presentation of the candidate content objects, e.g., to be presented only during an eligible time window and/or only during an eligible portion of the route. The candidate content objects may be displayed in a cart interface generated by the smart cart. The cart interface may display information such as in-store visit information, user data, obtained items (i.e., items in cart), item recommendations, or some combination thereof. The cart interface may include user-selectable options for interacting with the cart interface. The recommended items may be displayed together, or one at a time. The user may also swipe through the recommended items. The smart cart may also display navigation instructions for a recommended item.

As the user navigates through the in-store environment and obtains items, the smart cart may automatically perform some or all of the process 500 to detect items and to fine-tune one or more of the machine-learning models. For example, as the user obtains a candidate content object that was presented according to presentation constraints, the machine-learning recommendation model and/or the machine-learning presentation model may be fine-tuned.

### Example Cart Interfaces

FIGS. 6 & 7 illustrate cart interfaces that may be displayed by a smart cart on an electronic display. The cart interfaces may include one or more item recommendations determined by a recommendation model. The cart interface may be generated by a smart cart (e.g., the smart cart 170 or the smart cart 300) or an online system (e.g., the online system 140) in communication with the smart cart.

FIG. 6 is a first example cart interface 600 presenting recommended items, in accordance with one or more embodiments. The cart interface 600 includes three panels: an information pane 610, items in cart 620, and item recommendations 630. The information pane 610 provides information relating to the in-store visit and/or the user. For example, the information pane 610 includes one or more tabs related to a user loyalty program. The information pane 610 may also include a tab to show a list curated by the user prior to the in-store visit. The information pane 610 may also current order information, e.g., a total for items in the cart, a total of savings, etc. The items in cart 620 show the obtained items, e.g., as detected by the smart cart. Each item may be selected, which may have specific recommended items. For example, the recommendation model may output a first list of recommended items for a first item and a second list of recommended items for a second item, wherein the second list of recommended items may include one or more different recommended items. The item recommendations 630 display the recommended items, e.g., as determined by the smart cart via the recommendation model. In one or more embodiments, the recommended items may be displayed in a grid. In other embodiments, the recommended items may be displayed in a list, in a swipeable interface, or some other display manner.

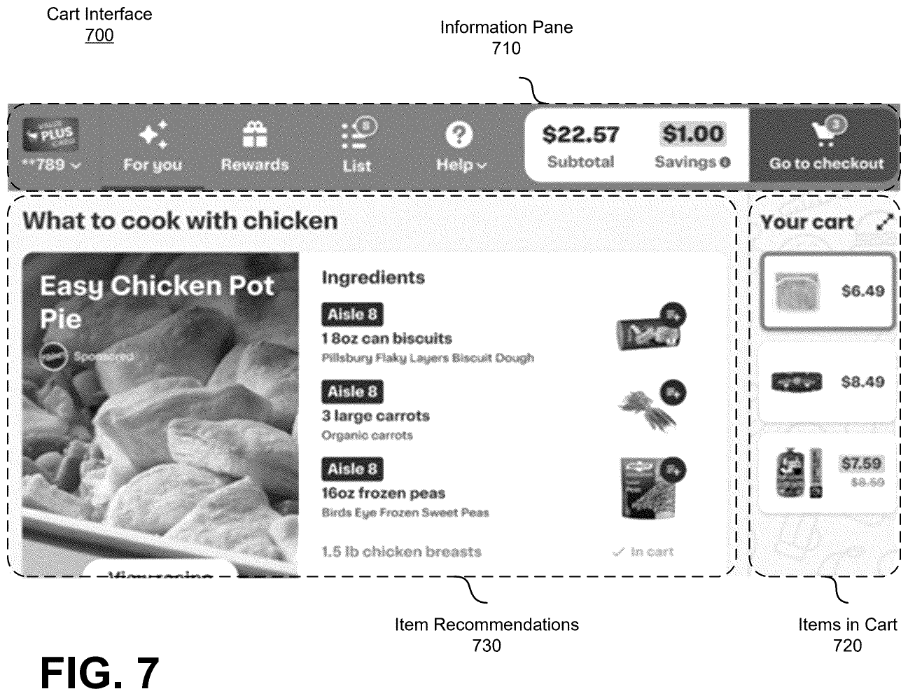

FIG. 7 is a second example cart interface 700 presenting recommended items, in accordance with one or more embodiments. The cart interface 600 includes three panels: an information pane 710, items in cart 720, and item recommendations 730. The information pane 710 may display similar information as the information pane 610 shown in FIG. 6. The items in cart 720 may display similar information as the items in cart 620 shown in FIG. 6. The item recommendations 730 in FIG. 7 show a recommended recipe based on items in cart 720. In the embodiment shown, chicken is an obtained item, and the item recommendations 730 display a recommended recipe with one or more needed items for the recipe.

In both example cart interfaces, the cart interfaces may further include navigation instructions for navigating the user to the recommended items. In the embodiments shown, each recommended item may include a visual tag indicating a location of the recommended item (e.g., “Aisle 8”). In other embodiments, the user may select the recommended item, and the cart interface may provide more detailed instructions for navigating to the selected item. In some embodiments, the cart interface can also display some indication to the current location of the smart cart (e.g., “You're in Aisle 5” or a map of the in-store environment).

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor may comprise one or more subprocessing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed by a computer system comprising a processor and a non-transitory computer-readable medium, comprising:
obtaining, from a user database, user data describing a user of a smart cart;
obtaining, from an item database, a plurality of candidate content objects to be presented to the user of the smart cart, wherein the plurality of candidate content objects relate to items located within an environment around the smart cart;
obtaining, via a location sensor of the smart cart, a location of the smart cart in an environment during a trip;
applying a machine-learning route prediction model to the location of the smart cart and the obtained user data to predict a future route of the smart cart through the environment;
identifying, for each candidate content object, one or more presentation constraints based on the future route that constrain presentation of the candidate content object to the user, wherein the one or more presentation constraints include a time window to present the candidate content object; and
presenting, via an electronic display of the smart cart, one or more of the candidate content objects according to the presentation constraints including the time window.

2. The method of claim 1, further comprising:
identifying the plurality of candidate content objects by applying a machine-learning recommendation model to items in the smart cart.

3. The method of claim 2, further comprising:
obtaining historical data indicating past items obtained by the user in past trips,
wherein applying the machine-learning recommendation model comprises applying the machine-learning recommendation model further to the historical data to identify the plurality of candidate content objects.

4. The method of claim 2, wherein the machine-learning recommendation model is trained by:
obtaining historical data indicating past trips by a plurality of users, wherein each past trip indicates items obtained by the user, candidate content objects presented during the past trips;
scoring each candidate content object presented during the past trips based on whether one or more of the plurality of users obtained the candidate content object subsequent to presentation; and
training the machine-learning recommendation model based on the scores for the candidate content objects.

5. The method of claim 1, wherein obtaining, via the location sensor of the smart cart, the location of the smart cart in the environment comprises iteratively obtaining, via the location sensor of the smart cart, the location of the smart cart over a plurality of timestamps of the trip through the environment, and wherein applying the machine-learning route prediction model comprises iteratively applying the machine-learning route prediction model to the locations of the smart cart over the plurality of timestamps of the trip and the obtained user data to iteratively predict the future route of the smart cart through the environment.

6. The method of claim 1, wherein presenting, via the electronic display of the smart cart, one or more of the candidate content objects according to the presentation constraints including the time window comprises:
filtering out one or more candidate content objects from presentation based on the presentation constraints to yield a remaining subset of candidate content objects;
scoring each candidate content object in the remaining subset based on the user data and item data associated with the one or more items related to the candidate content object;
selecting a first candidate content object to present based on the scores; and
presenting the first candidate content object via the electronic display of the smart cart.

7. The method of claim 1, wherein the machine-learning route prediction model is trained on past trips by one or more users of a fleet of one or more smart carts in the environment.

8. The method of claim 1, further comprising:
updating the machine-learning route prediction model by:
obtaining, via the location sensor, at a subsequent timestamp during a remainder of the trip a subsequent location of the smart cart in the environment;
generating a score for the future route based on the subsequent location of the smart cart; and
fine-tuning the machine-learning route prediction model based on the score.

9. The method of claim 1, wherein obtaining, via the location sensor of the smart cart, the location of the smart cart in the environment during the trip comprises:
tracking, with the location sensor, a traveled route of the smart cart in the environment during the trip,
wherein applying the machine-learning route prediction model comprises applying the machine-learning route prediction model to the traveled route to identify the future route of the smart cart.

10. The method of claim 1, wherein:
applying the machine-learning route prediction model comprises applying the machine-learning route prediction model to output a set of possible future routes likely to be traversed by the smart cart,
identifying, for each candidate content object, the one or more presentation constraints comprises determining a first presentation constraint for a first candidate content object to present the first candidate content object conditioned on the smart cart traveling along a first route of the set of possible future routes, and
presenting, via the electronic display, the one or more candidate content objects according to the presentation constraints comprises:
identifying, at a subsequent timestamp, that the smart cart is traveling along the first route, and
responsive to identifying that the smart cart is traveling along the first route, presenting the first candidate content object on the electronic display according to the first presentation constraint.

11. The method of claim 8, wherein determining the time window for each candidate content object comprises:
partitioning the remainder of the trip into the time windows for the candidate content objects.

12. The method of claim 1, wherein determining, for each candidate content object, the one or more presentation constraints comprises:
identifying, for each candidate content object, a portion of the route to present the candidate content object during a remainder of the trip based on the future route.

13. The method of claim 1, wherein determining, for each candidate content object, the one or more presentation constraints comprises:
applying a machine-learning presentation model to the future route and the candidate content object to determine one or more presentation constraints for the candidate content object.

14. The method of claim 13, wherein the machine-learning presentation model is trained by:
obtaining historical data indicating past trips by a plurality of users, wherein each past trip indicates a route traveled by the smart cart, candidate content objects presented during the route;
scoring each candidate content object presented during the route based on whether one or more of the plurality of users obtained the candidate content object subsequent to presentation; and
training the machine-learning presentation model based on the scores for the candidate content objects.

15. A non-transitory computer-readable medium storing instructions that, when executed by a computer processor, cause the computer processor to perform operations comprising:
obtaining, from a user database, user data describing a user of a smart cart;
obtaining, from an item database, a plurality of candidate content objects to be presented to the user of the smart cart, wherein the plurality of candidate content objects relate to items located within an environment around the smart cart;
obtaining, via a location sensor of the smart cart, a location of the smart cart in an environment during a trip;
applying a machine-learning route prediction model to the location of the smart cart and the obtained user data to predict a future route of the smart cart through the environment;
identifying, for each candidate content object, one or more presentation constraints based on the future route that constrain presentation of the candidate content object to the user, wherein the one or more presentation constraints include a time window to present the candidate content object; and
presenting, via an electronic display of the smart cart, one or more of the candidate content objects according to the presentation constraints including the time window.

16. The non-transitory computer-readable medium of claim 15, wherein obtaining, via the location sensor of the smart cart, the location of the smart cart in the environment comprises iteratively obtaining, via the location sensor of the smart cart, the location of the smart cart over a plurality of timestamps of the trip through the environment, and wherein applying the machine-learning route prediction model comprises iteratively applying the machine-learning route prediction model to the locations of the smart cart over the plurality of timestamps of the trip and the obtained user data to iteratively predict the future route of the smart cart through the environment.

17. The non-transitory computer-readable medium of claim 15, wherein presenting, via the electronic display of the smart cart, one or more of the candidate content objects according to the presentation constraints including the time window comprises:
filtering out one or more candidate content objects from presentation based on the presentation constraints to yield a remaining subset of candidate content objects;
scoring each candidate content object in the remaining subset based on the user data and item data associated with the one or more items related to the candidate content object;
selecting a first candidate content object to present based on the scores; and
presenting the first candidate content object via the electronic display of the smart cart.

18. The non-transitory computer-readable medium of claim 15, the operations further comprising:
updating the machine-learning route prediction model by:
obtaining, via the location sensor, at a subsequent timestamp during a remainder of the trip a subsequent location of the smart cart in the environment;
generating a score for the future route based on the subsequent location of the smart cart; and
fine-tuning the machine-learning route prediction model based on the score.

19. The non-transitory computer-readable medium of claim 15, wherein obtaining, via the location sensor of the smart cart, the location of the smart cart in the environment during the trip comprises:
tracking, with the location sensor, a traveled route of the smart cart in the environment during the trip,
wherein applying the machine-learning route prediction model comprises applying the machine-learning route prediction model to the traveled route to identify the future route of the smart cart.

20. A smart cart comprising:
a location sensor for tracking a location of the smart cart in an environment;
an electronic display for presenting visual content to a user of the smart cart; and
a computing device comprising a computer processor and a non-transitory computer-readable storage medium storing instructions that, when executed by the computer processor, cause the computer processor to perform operations comprising:
obtaining, from a user database, user data describing a user of a smart cart;
obtaining, from an item database, a plurality of candidate content objects to be presented to the user of the smart cart, wherein the plurality of candidate content objects relate to items located within the environment around the smart cart;
obtaining, via a location sensor of the smart cart, a location of the smart cart in an environment during a trip;
applying a machine-learning route prediction model to the location of the smart cart and the obtained user data to predict a future route of the smart cart through the environment;
identifying, for each candidate content object, one or more presentation constraints based on the future route that constrain presentation of the candidate content object to the user, wherein the one or more presentation constraints include a time window to present the candidate content object; and
presenting, via an electronic display of the smart cart, one or more of the candidate content objects according to the presentation constraints including the time window.
